(19) United States
(12) Patent Application Publication
(10) Pub. No.: US 2005/0015293 A1
(43) Pub. Date: Jan. 20, 2005

(54) Collaboration enhanced workflow system

(75) Inventors: Horst Henn, Boeblingen (DE); Matthias Kloppmann, Sindelfingen (DE); Frank Leymann, Aidlingen (DE); Yoelle Maarek, Haifa (IL); Michael Rodeh, Haifa (IL); Juergen Schaeck, Achern (DE); Thomas Schaeck, Boeblingen (DE); Dafna Sheinwald, Haifa (IL)

Correspondence Address: Stephen C. Kaufman;Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/620,632

(22) Filed: Jul. 16, 2003

(51) Int. Cl. G06F 17/60

(52) U.S. Cl. 705/9

(57) ABSTRACT

A collaboration enhanced workflow system includes an interface unit at least to provide an interface to a workflow system for performing a selected workflow and an interface to a collaboration system within which the actors of the current instance of the selected workflow can collaborate.

### FIELD OF THE INVENTION

The present invention relates to workflow systems generally and to such systems which enable collaboration with the workflow in particular.

### BACKGROUND OF THE INVENTION

A workflow is a mechanism that aims to manage people, data, applications, and business processes throughout an organization, including external partners. The Workflow Management Coalition (WFMC, www. wfmc. org) establishes standards for workflow interfaces, external, internal and between the components.

An example workflow might be the approval and implementation of a travel request. For example, the workflow might involve the employee requesting the travel in order to go to a conference. The next step in the workflow might be that the boss needs to approve the travel request before the secretary can execute the request and find the employee an appropriate flight.

Through the workflow system, a flow designer designs a “workflow” related to the execution of a specific business process. The workflow is a directed graph of activities, some of which are executed by workflow servers handling process flows, and some are implemented by application functions. Some of the activities are assigned as work-items (WIs) for persons to carry out (i.e. the boss has to approve the request and the secretary has to find the flight and make the appropriate reservation). Work-items are the correlation between an activity and a person that is able to process the activity.

One important task is the identification of the persons eligible to carry out a specific WI. This task is referred to as “Staff Resolution” and can be handled by the flow designer, or by the workflow engine, using predefined rules. In some cases, the designer specifies the persons by their role in the organization, and at run-time, a component of the workflow engine which has access to the people directory in the organization, assigns the WI to specific, named, people.

The design connects different activities with connectors that may have a condition attached thereto. The connector will become active once the evaluated condition is True. Thus, workflows advance asynchronously. Furthermore, work items are assigned to people who become aware of their existence either by getting an asynchronous email notification or by proactively accessing their workflow system and verifying what pending work items they are supposed to process.

Previous work identified the need to extend the workflow operation to ensure faster processing. In particular, the article by Michael Weber et al. “Integrating Synchronous Multimedia Collaboration into Workflow Management”, Proc. GROUP '97 International Conference on Supporting Group Work the Integration Challenge, offers different modes of integrating multimedia conferencing within workflow systems. The main motivation behind this work is to enable WIs to be carried out by several people together, simultaneously, or even to enable work on several WIs together, thus breaking the asynchronous mode constraint. The integration between the (so called) conference activity and the workflow activities has a range of modes: from total ignorance to semi-automated monitoring. In the case of total ignorance, people initiate the conference without any information being automatically conveyed to the workflow system and the people in the conference have to manually provide the conference results into the subsequent WI. In the semi-automated monitoring mode, the workflow system monitors the conference, by breaking the latter into a sequence of small conference activities, connected the way WIs are connected, and part of the conference activity is reporting the results/decision into Workflow. In all of these modes, someone must input the conference decisions into the workflow, and must control the tracking and logging thereof.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a collaboration enhanced workflow system, constructed and operative in accordance with a preferred embodiment of the present invention;

FIGS. 2A, 2B and 2C are illustrations of exemplary screens produced by one implementation of the system of FIG. 1, useful in understanding the operation of the system of FIG. 1;

FIG. 3 is a block diagram illustration of one embodiment of the system of FIG. 1;

FIG. 4 is a block diagram illustration of an alternative embodiment of the system of FIG. 1; and

FIG. 5 is a block diagram illustration of a further alternative embodiment of the system of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

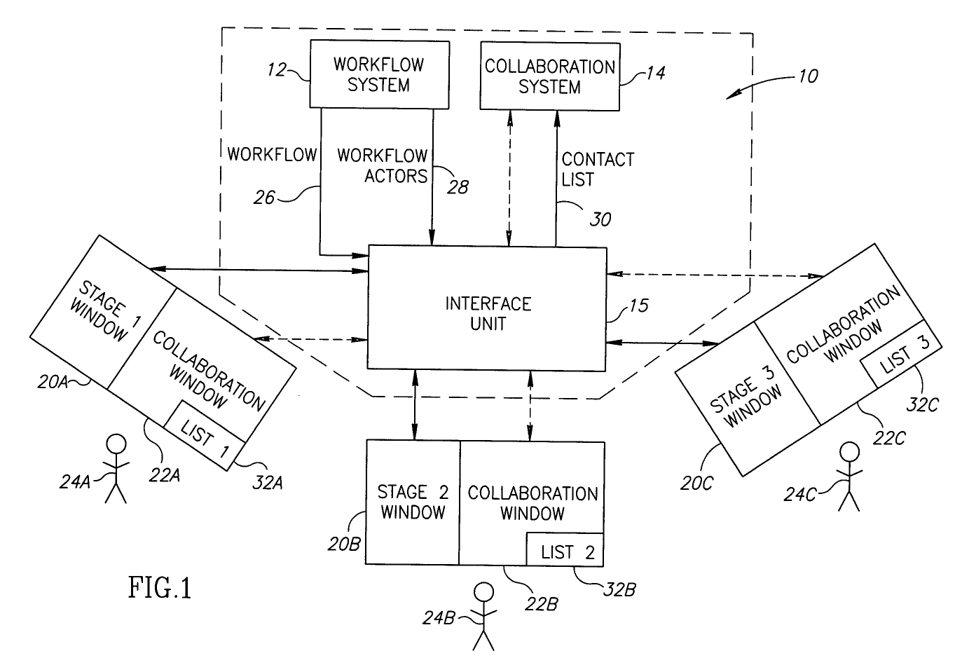

Applicants believe that there is a need for tighter integration of collaboration in the workflow process and in business processes in general. Reference is now made to FIG. 1, which illustrates a collaboration enhanced workflow system 10 and one exemplary operation thereof. System 10 may be formed of a workflow system 12, a collaboration system 14 and an “interface” unit 15. An exemplary workflow system 12 might be the MQ Series Workflow, commercially available from International Business Machines Inc. (IBM) and an exemplary collaboration system might be an instant messaging system or a Chat system. One such instant messaging system is Lotus Sametime Connect, also commercially available from IBM.

Interface unit 15 may provide interfaces to workflow system 12 and to collaboration system 14. Interface unit 15 may implement activity windows 20 associated with the workflows of workflow system 12 and may implement collaboration windows 22 which provide a workflow actor 24 operating one of activity windows 20 with access to collaboration system 14. Typically, a workflow might have multiple stages of operation and each stage might have a different activity window 20, for example, windows 20A, 20B and 20C, associated therewith.

Workflow system 12 may provide a workflow 26 and a list 28 of actors associated with a current instance of workflow 26 to interface unit 15. As will be described in more detail hereinbelow, list 28 may list at least workflow actors who process the work items of the current workflow 26. It may also list external actors who may help the workflow actors to process the work items. The external actors may be part of the organization or may be external to it.

The design of a workflow typically includes designing the directed graph and assigning a role in the organization to each activity in the graph. The person whose role it is will perform the activity when he works within the workflow. The runtime component of workflow system 12 may control the advancement of specific instances of workflow, e.g., instances of travel requests, and may consult with the organization directories as to who is to perform the different work items of the workflow.

Interface unit 15 may generate the relevant activity windows 20 for the current workflow and may make them available to the workflow actors of the current instance of the workflow. For example, if the current workflow 26 is a travel request, the activity windows 20 might be related to filing a request 20A, approving the request 20B and implementing the request 20C and the workflow actors might be an employee 24A, his boss 24B and a secretary 24C. Moreover, for a particular instance of travel request workflow 26, employee 24A might be Joe, his boss 24B might be Gordon and the secretary 24C might be Mary.

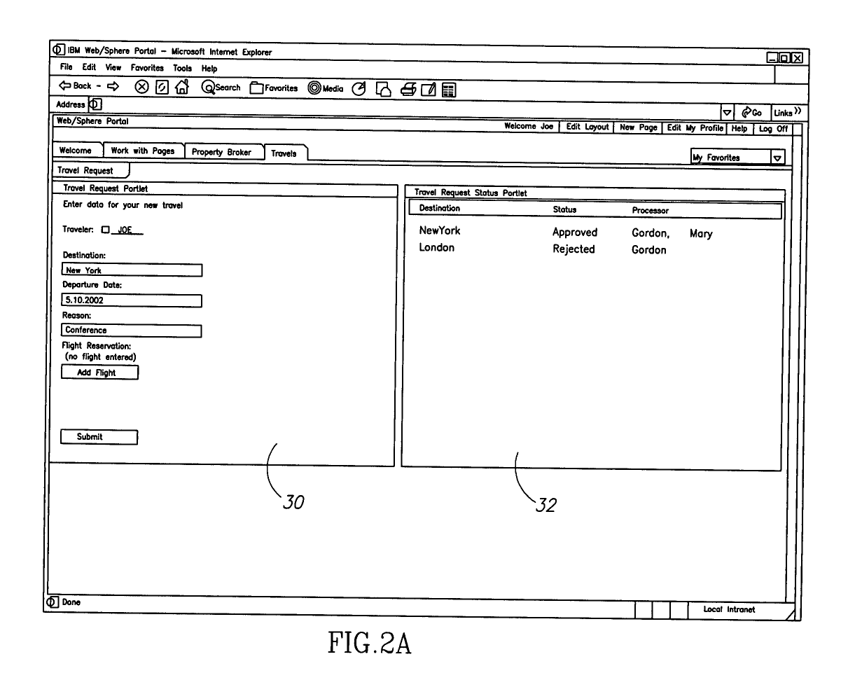

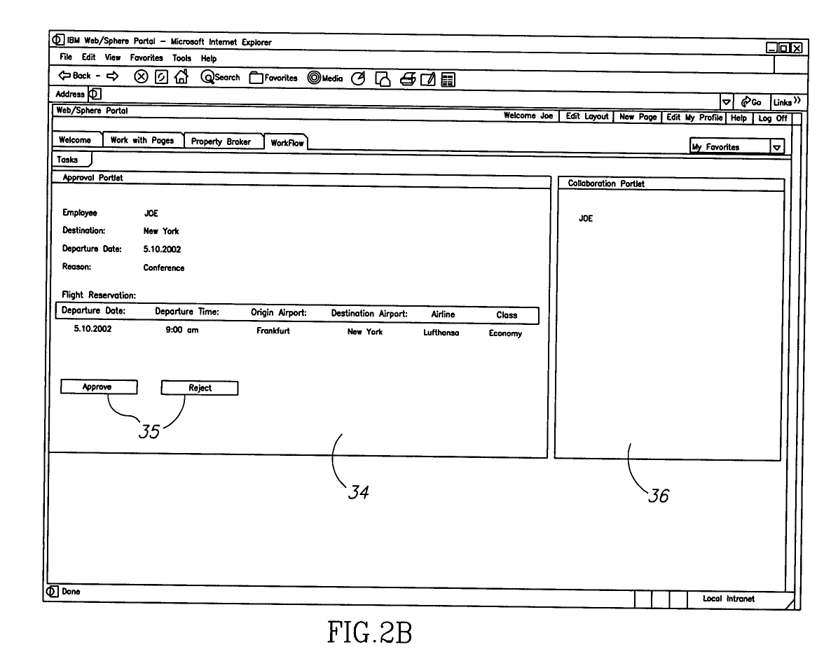

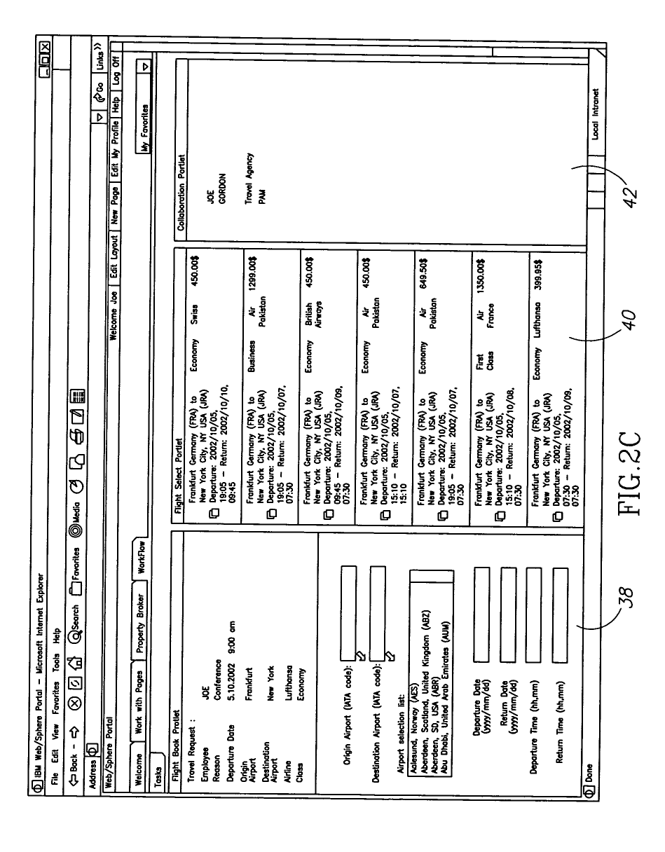

Reference is now briefly made to FIGS. 2A, 2B and 2C which are exemplary screens for a travel request for one embodiment of collaboration enhanced workflow system 10; other embodiments are possible and are incorporated in the present invention. Moreover, the travel request workflow is only an exemplary workflow; other workflows are possible and are incorporated in the present invention.

FIG. 2A shows a travel request portlet 30 and a travel request status portlet 32, both types of activity windows 20. Travel request portlet 30 asks Joe to enter his travel request information—destination, departure date and reason for going. Travel request status portlet 32 shows the status of two exemplary requests; one of which is approved and one is not.

The activity window in FIG. 2B is an approval portlet 34, which asks Gordon to approve Joe's flight request. It lists Joe's flight request, the reservation and it has approve and reject buttons 35 to provide authorization or to decline authorization for the travel request. FIG. 2B also shows a collaboration portlet 36, similar to a collaboration window 22 of FIG. 1, in which Gordon can communicate with Joe about his request. For example, Gordon might want to check with Joe that the conference he is going to (and for which he requested approval of his travel request) is truly necessary and useful. Gordon can copy any of the data in approval portlet 34 into communication portlet 36 to ease writing of his question or to comment to Joe. Joe may then respond, helping Gordon to make his decision.

Alternatively, Gordon may send a link to the request data, where a link may be a string of characters that, when clicked upon, opens a window with the data referred to. It will be appreciated that sending a link is possible only when the collaboration is via text, as in the present invention. It is not possible if the collaboration is via multimedia, as suggested in the prior art.

FIG. 2C shows a flight book portlet 38, a flight select portlet 40 and a collaboration portlet 42. Mary may utilize flight book portlet 38 to book a flight for Joe. She may utilize flight select portlet 40 to determine which flights are available and to select (typically by a click on the selected flight listing) the relevant one for Joe. If she has a question for Joe, she may use collaboration portlet 42. She may even copy, or send links to, the information about the possible choices into collaboration portlet 42 so that Joe may choose among her selections. She may also utilize collaboration window portlet 42 to check with Gordon on the range of prices he authorizes for the flights. As mentioned hereinabove, the contact list may also include external actors. For example, it may include contacts at the travel agency with whom the company works. A travel agent Pam is listed in FIG. 2C and Mary may contact Pam with questions via collaboration portlet 42. Once Mary has finished reserving the flight, she may want to use collaboration portlet 42 to inform one or both of Gordon and Joe of this fact.

Returning to FIG. 1, at each stage of the current workflow (three stages are shown in FIG. 1), interface unit 15 may provide collaboration system 14 with a contact list 30 of the current actors of workflow 26. Contact list 30 may include all of the workflow actors, or a subset, or a superset (i.e. the workflow actors plus external actors who may be useful for performing the workflow). One exemplary subset might be the actors who have worked on the previous stages of the current instance of workflow 26.

In one embodiment of the invention, interface unit 15 may activate a “staff resolution” component of workflow system 12 to determine the workflow actors of the current instance of the current workflow. In addition, the staff resolution component may provide any other actors associated with the current workflow (i.e. external actors, such as contacts at a supplier, e.g. at the travel agency). In this embodiment of the invention, the workflow designer may define all employees and any external actors who either are useful to the workflow or who might be involved in the decision-making process.

Interface unit 15 may create contact list 30 in any appropriate manner. In one embodiment, the workflow designer may define the workflow actors by their roles and may store this information in workflow system 12. Interface unit 15 may resolve the roles when the current instance of the workflow is activated to determine who actually is an actor. In another embodiment, interface unit 15 may generate contact list 30 from the people that have already worked on this instance of workflow 26.

In one embodiment, contact list 30 may include the name and address within collaboration system 14 of each actor. In another embodiment, contact list 30 may also include other contact information, such as the email address, telephone number(s) and office address of each actor.

At each stage of the current workflow, interface unit 15 may provide collaboration system 14 with access to collaboration window 22 with which actor 24 may communicate with any of the actors of current contact list 30. In accordance with a preferred embodiment of the present invention, each collaboration window 22 includes a list 32 listing the members of contact list 30 at that stage.

List 32 may include an indication of the “awareness” or activity state of the other actors to provide the current actor with knowledge of who is available to ask questions. This is common in instant messaging systems.

It will be appreciated that collaboration system 14 may provide the present invention with the ability to transfer links to further webpages where data of use to the workflow actors may be found.

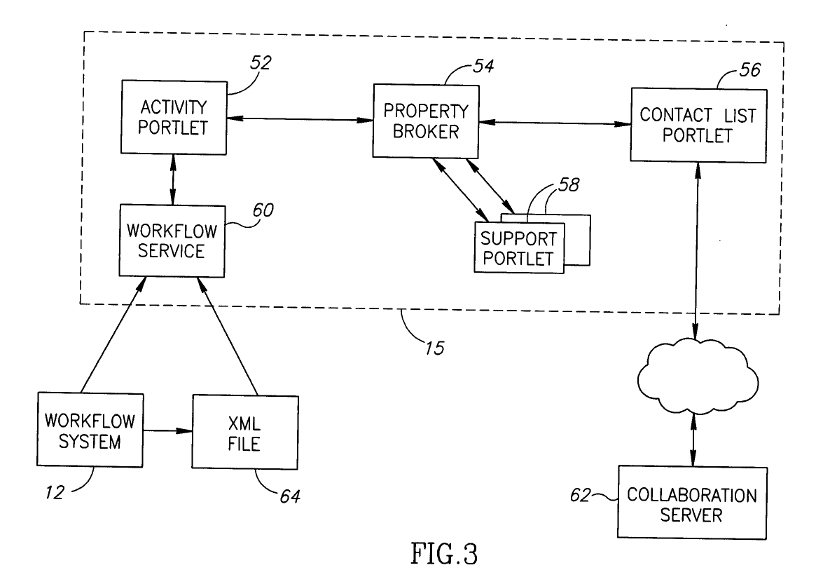

Reference is now made to FIG. 3, which illustrates one embodiment of interface unit 15, implemented as portlets within a portal. As is known in the art, a portal is an access point for web-based services and a portlet is the application running one of the web-based services. On the user side, the output of the portlet is rendered in the user's web browser.

An exemplary portal might be WebSphere Portal, from IBM, which runs on the WebSphere Application Server platform, also from IBM. Typically, a database subsystem, such as the DB2 Universal Database, commercially available from IBM or any database from Oracle Corporation, may be used to store configuration data. An LDAP source, such as IBM SecureWay Directory, Lotus Domino Directory Services, or Microsoft Active Directory, commercially available from IBM or Microsoft Corporation, is used by WebSphere Application Server and WebSphere Portal for authentication and authorization within the portal.

System 15 comprises an activity portlet 52, a property broker 54, a contact list portlet 56, at least one support portlet 58 and a workflow service 60. Activity portlet 52 may provide the structure to follow a particular workflow and may gather the relevant information from the actors performing the workflow. For example, activity portlet 52 may implement the activity windows 30, 34 and 38 of the exemplary workflow of FIGS. 2A, 2B and 2C. In this example, activity portlet 52 may collect the information of the travel request, may display the travel request to the authorizing boss asking for authorization and may display the travel request to the implementing secretary only once the boss has provided his authorization. In addition, activity portlet 52 may collect the information of the selected reservation.

Activity portlet 52 may request all data needed in the context of the task. To do so, it may utilize workflow service 60 which may access either workflow management system 12 or any other external input, such as an XML file 64. For example, activity portlet 52 may request the actors for the current workflow. If necessary, activity portlet 52 may also request the workflow itself.

As activity portlet 52 may move through its program, there may be information it needs to collect from support portlets 58 and it may need to provide them with information it has collected. In the travel request example, one piece of information might be the information about the selected reservation.

In the present invention, the various portlets (activity portlet 52, support portlets 58 and contact list portlet 56) register with property broker 54 a list of properties that need to be exchanged. Property broker 54 then transfers these properties among portlets 52, 56 and 58 as they are needed.

In one embodiment, interface unit 15 may be written in Java, the portlets may be written as Java Server Pages (JSPs) and the properties to be transferred may be stored in “JavaBeans”. A JavaBean provides methods to change the values of the properties stored therein and may be used as data transfer objects between JSPs or between servlets and JSPs. A servlet is a dynamically loaded module that services requests from a Web server.

In FIG. 2C, flight book portlet 38 (an activity portlet) shows the information about the employee's request, i.e. the name of the employee and corresponding flight information (destination, date, time, etc.). Flight select portlet 40 (a support portlet) displays a list of available flights that fit the employee's request. A click on a selected flight may copy the flight information to flight book portlet 38. Collaboration portlet 42 shows a contact list with a set of persons that might support the secretary when performing the activity. Thus, the flight information and the names for the contact list, properties from flight book portlet 38, are registered with property broker 54 who delivers them to the appropriate portlet as requested.

Property broker 54 may be a standard feature of portal software and thus, will not be further described.

Contact list portlet 56 may be a support portlet that may display a dynamically created contact list. The properties portlet 56 may receive, for example, the names of the persons that make up contact list 30 from activity portlet 52 which may receive them from workflow service 60. Contact list 30 may change as a function of the work item to be processed—certain work items may have more people who can help the workflow actor in processing the work item. In one embodiment, the roles of the contacts for each work item may be defined by the workflow designer and thus, may be stored in workflow system 12. In another embodiment, the roles may be defined in activity portlet 52.

For each name in contact list 30, contact list portlet 56 may check on a collaboration server 62, such as one forming part of collaboration system 14, the online status of the persons listed in the list and may list this status. This may be considered an “awareness” state. When a workflow actor may click on one of names on the list, contact list portlet 56 may transfer control to collaboration server 62. Server 62 may then implement the communication channel between workflow actors.

Support portlet 58 may be any portlet which may be necessary for performing the job of the workflow.

Workflow service 60 may be any service that may retrieve necessary data (person names) from workflow system 12 (where default values have been stored) and/or by reading them data from an external file, such as XML file 64. XML file 64 may originally get its information from workflow system 12. Service 60 may load the workflow actors list, either by reading default values from the workflow system 12 or by parsing XML file 64, such as by using Simple API for XML, commercially available from many vendors such as The Apache Software Foundation of the USA, and resolving the roles and referenced names listed in XML file 64.

Within workflow system 12, a data structure may be defined which may store a set of groups, where each group stores a set of group members. For example, a group might be “travel agencies” and the members might be the contact persons at the various travel agencies that the company uses

XML file 64 may store a set of groups, where each group may store a set of group members. Like for workflow system 12, XML file 64 may define for each activity a set of groups. With XML file 64, roles may be added as well, where a role is a predefined set of person names.

Roles may be “absolute” or “reference” values, where “absolute” means that the name is presented as specified and “reference” means that the actual name has to be looked up somewhere else (e.g. in a properties file). Predefined member names may also be defined that have a predefined functionality. For example, using the name “previousworkers” may cause everyone who previously worked on the process to be inserted.

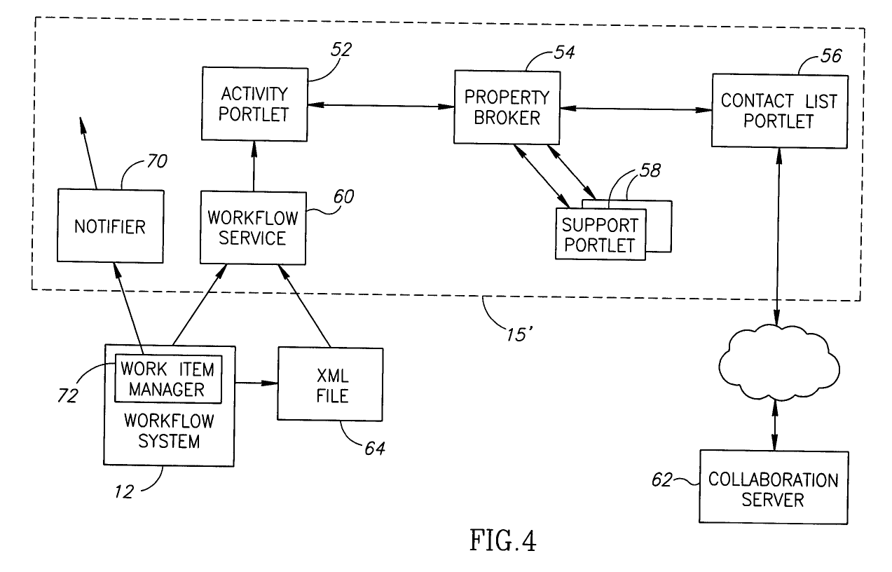

Reference is now made to FIG. 4, which illustrates an alternative embodiment of the present invention which adds notification of the presence of a work item to the collaboration enhanced workflow of the present invention. The alternative embodiment of FIG. 4 comprises similar items to those of FIG. 3 and thus, similar reference numerals are utilized to refer to similar items.

In this system, interface unit, here labeled 15′, also may include a notifier 70, which may receive a notification of a new work item from a work item manager 72 forming part of workflow system 12. Notifier 70 may then invoke a message dispatcher, forming part of the portal, who may determine about how to inform the user about the pending task. Notification may be realized by any appropriate means. In one embodiment, notifier 70 may send a mail message. In another embodiment, notifier 70 may send a WAP Push message where a WAP Push message is a message sent to a mobile subscriber without an explicit request from the subscriber at the time the message is delivered. In another embodiment, notifier 70 may instruct collaboration server 62 to send an instant massage.

For all the examples, the notification message may contain a hyperlink that leads the user to activity portlet 52 where the user may process the task. Activity portlet 52 may be in the appropriate format (either HTML for the mail message or WML for the WAP Push message) for the user to access it.

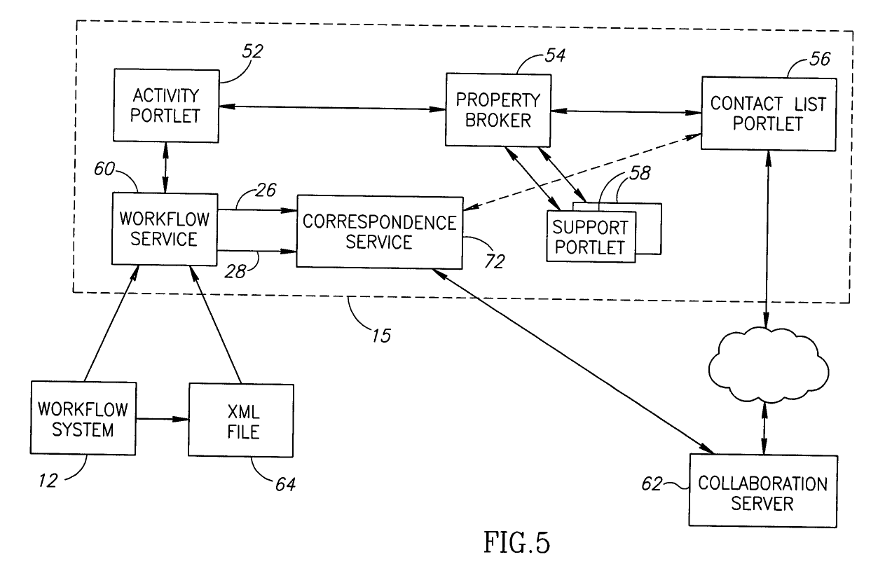

Reference is now made to FIG. 5, which illustrates a further alternative embodiment of the present invention which adds a correspondence service 72 to the collaboration enhanced workflow of the present invention. The alternative embodiment of FIG. 5 comprises similar items to those of FIG. 3 and thus, similar reference numerals are utilized to refer to similar items.

Correspondence service 72 may communicate with collaboration server 62 and may maintain an open correspondence, through server 14, for each currently active workflow. Correspondence service 72 may also store the total correspondence history for any prior workflow. A prior workflow may be defined as a prior instance of the workflow or a prior workflow performed by the same employee.

For each currently active workflow, correspondence service 72 may receive workflow 26 and list 28 of workflow actors from workflow system 12 or from workflow service 60. Correspondence service 72 may generate a ‘place’ for workflow actors 24 to communicate, via collaboration server 62, about the particular workflow 26. Furthermore, correspondence service 72 may store the correspondence. When a workflow actor 24 may enter the place for the current workflow 26, correspondence service 72 may provide actor 24 with the entire correspondence about current workflow 26, to which actor 24 may add.

Correspondence service 72 may require that actors 24 respond within a short period of time, for example, within an hour of being notified that another actor 24 wishes to communicate with him, after which correspondence service 72 may notify the calling actor 24 that a communication is not possible.

In one embodiment, correspondence service 72 may save whatever correspondence is generated among the workflow actors 24. In this embodiment, the workflow instance may move from actor to actor, directed by the workflow logic, and correspondence service 72 may accumulate textual input.

In another embodiment, correspondence service 72 may provide a connection between a name in contact list 32 and workflow 26. When the sender 24 may click on a name in contact list 32, correspondence service 72 may open a window on his screen into which a link to this instance of workflow 26 may be listed within a message of the type that collaboration server 62 produces. Sender 24 may then send the message through collaboration server 62. Receiver actor 24 may click on the link inside the message which will bring receiver 24 to workflow 26 and to the work item in workflow 26 that is currently open to be performed.

In a further embodiment, correspondence service 72 may indicate to workflow system 12 to transfer responsibility for the currently open work item from sender 24 to receiver actor 26. Correspondence service 72 may communicate with workflow system 12 to determine that the currently open work item is not being processed via any other route and that it is available for receiver actor 26.

For all three embodiments, correspondence service 72 may store the correspondence associated with the current workflow.

In a further embodiment, correspondence service may also screen the accumulated text in accordance with the person reviewing it. This may enable certain types of discussions between the manager and the employee to be kept from the assistant making the reservation. For example, the reason for the trip may be a secret or the manager may desire that certain ‘naughty’ words or turns of phrase not be shown to the assistant.

It will be appreciated that the embodiments of FIGS. 4 and 5 may be combined, such that an interface unit 15 may include both notifier 70 and correspondence service 72. In this embodiment, notifier 70 may be invoked by an actor that needs the help of the addressee of the notification. The addressee, having reviewed the place linked by the hyperlink, may respond via collaboration server 62, and the caller for the help may then complete his processing of the work item in accordance to the response.

In another embodiment, notifier 70 may be invoked by an actor who wants to pass over the WI execution on to the addressee. Alternatively, when no one processes the work item, correspondence service 72 may invoke notifier 70 to notify a selected addressee when collaboration system 62 may identify that the addressee is aware. For both situations, correspondence service 72 may send a link to the work item, at which place the addressee may complete the work item.

In another embodiment, a message may be extended, via notifier 70 or via the collaboration server 62, for a limited time, i.e. with a deadline. The message may expire if there is no response to it by the deadline and its invoker may decide whether to forward the message to another addressee, or to act otherwise.

In one embodiment, notifier 70 (or collaboration server 62) may extend such messages from one addressee to another, waiting a limited time for each to respond, until one addressee does respond, or the list provided by the invoker, is exhausted. In a further embodiment, the invoker (notifier 70 or collaboration server 62) may extend the message to the entire contact list 30 in parallel, and may wait until any of them responds. When one addressee may start to respond, the invoker may notify the others that they do not have to respond.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system comprising:
a workflow system to provide a structure for a plurality of workflows and information regarding the workflow actors who are to perform a given workflow; and
an interface unit at least to provide an interface to said workflow system for performing a selected workflow and an interface to a collaboration system within which the actors of the current instance of said selected workflow can collaborate.

2. A system according to claim 1 and wherein said interface unit comprises a support interface per support application, wherein said support application supports the work of said selected workflow.

3. A system according to claim 1 and wherein said actors comprise at least one of the following: workflow actors and external actors.

4. A system according to claim 3 and wherein said interface unit comprises a notifier to notify at least one workflow actor that a work item is waiting for him/her to act upon.

5. A system according to claim 4 and wherein said notifier comprises means for producing a hyperlink to said awaiting work item.

6. A system according to claim 1 and also comprising a correspondence unit to accumulate correspondences of said actors when performing said current instance of said selected workflow.

7. A system according to claim 6 and wherein said correspondence unit comprises means for sending a hyperlink to a location where a workflow actor may process a work item.

8. A system according to claim 7 and wherein said correspondence unit additionally comprises means for transferring control of a work item from a first workflow actor to a second workflow actor.

9. A system according to claim 1 and wherein each said interface includes a portlet.

10. A system according to claim 2 and wherein said support interface includes a portlet.

11. A system according to claim 1 and wherein said interface unit comprises means for providing a contact list of at least of some of said actors to said collaboration system.

12. A system according to claim 11 and wherein said means for providing comprises means for activating a staff resolution component of said workflow system to determine said actors for said current workflow.

13. A system according to claim 12 and wherein said means for activating comprises means for selecting a portion of said actors according to a current work item to be performed.

14. A method comprising:
in one screen, providing an interface to a workflow system for performing a selected workflow and an interface to a collaboration system within which actors of a current instance of a selected workflow can collaborate.

15. A method according to claim 14 and wherein said actors comprise at least one of the following: workflow actors and external actors.

16. A method according to claim 14 and also comprising notifying at least one workflow actor that a work item is waiting for him/her to act upon.

17. A method according to claim 16 and wherein said notifying comprises producing a hyperlink to said awaiting work item.

18. A method according to claim 14 and also comprising accumulating correspondences of said actors when performing said current instance of said selected workflow.

19. A method according to claim 18 and wherein said accumulating comprises sending a hyperlink to a location where a workflow actor may process a work item.

20. A method according to claim 18 and wherein said accumulating comprises transferring control of a work item from a first workflow actor to a second workflow actor.

21. A method according to claim 14 and wherein said providing comprises providing a contact list of at least of some of said actors to said collaboration system.

22. A method according to claim 21 and wherein said second providing comprises activating a staff resolution component of said workflow system to determine said actors for said current workflow.

23. A method according to claim 21 and wherein said activating comprises selecting a portion of said actors according to a current work item to be performed.

24. A computer product readable by a machine, tangibly embodying a program of instructions executable by the machine to perform method steps, said method steps comprising:
in one screen, providing an interface to a workflow system for performing a selected workflow and an interface to a collaboration system within which actors of a current instance of a selected workflow can collaborate.

25. A product according to claim 24 and wherein said actors comprise at least one of the following: workflow actors and external actors.

26. A product according to claim 24 and also comprising notifying at least one workflow actor that a work item is waiting for him/her to act upon.

27. A product according to claim 25 and wherein said notifying comprises producing a hyperlink to said awaiting work item.

28. A product according to claim 25 and also comprising accumulating correspondences of said actors when performing said current instance of said selected workflow.

29. A product according to claim 28 and wherein said accumulating comprises sending a hyperlink to a location where a workflow actor may process a work item.

30. A product according to claim 28 and wherein said accumulating comprises transferring control of a work item from a first workflow actor to a second workflow actor.

31. A product according to claim 24 and wherein said providing comprises providing a contact list at least of some of said actors to said collaboration system.

32. A product according to claim 31 and wherein said second providing comprises activating a staff resolution component of said workflow system to determine said actors for said current workflow.

33. A product according to claim 31 and wherein said activating comprises selecting a portion of said actors according to a current work item to be performed.
